(19) United States
(12) Patent Application Publication
(10) Pub. No.: US 2025/0236972 A1
(43) Pub. Date: Jul. 24, 2025

(54) Alkaline Electrolyzer with Cooled Bipolar Electrode

(71) Applicant: Stiesdal Hydrogen A/S, Give (DK)

(72) Inventors: Henrik STIESDAL, Odense C (DK); Niels Vinter VOIGT, Aarhus N (DK); Thomas Tøttrup JENSEN, Brande (DK)

(21) Appl. No.: 19/173,945

(22) Filed: Apr. 9, 2025

Related U.S. Application Data
(63) Continuation of application No. PCT/DK2023/050241, filed on Oct. 10, 2023.

(30) Foreign Application Priority Data
Oct. 11, 2022 (DK) PA 2022 00923

(51) Int. Cl. C25B 11/036; C25B 9/23; C25B 9/67; C25B 9/75; C25B 9/77; C25B 11/031

(52) U.S. Cl. CPC C25B 11/036; C25B 9/23; C25B 9/67; C25B 9/75; C25B 9/77; C25B 11/031

(57) ABSTRACT

Electrolyzer for production of hydrogen gas and comprising a stack of bipolar electrodes sandwiching ion-transporting membranes between each two of the bipolar electrodes. Each bipolar electrode comprises two metal plates welded together back-to-back forming a coolant compartment in between and having a respective anode surface and an opposite cathode surface, each of which is abutting one of the membranes. The plates are embossed with a major vertical channel and minor channels in a herringbone pattern for transport of oxygen and hydrogen gases. The embossed herringbone pattern is provided on both sides of the metal plates so as to also provide coolant channels in a herringbone pattern inside the coolant compartment.

### CROSS-REFERENCE TO RELATED APPLICATIONS

This application is a continuation under 35 U.S.C. 111 of International Patent Application No. PCT/DK2023/050241, filed Oct. 10, 2023, which claims the benefit of and priority to Danish Application No. PA 2022 00923, filed Oct. 11, 2022, each of which is hereby incorporated by reference in its entirety.

### FIELD OF INVENTION

The present invention relates to an alkaline electrolyzer for production of hydrogen gas, comprising a stack of bipolar electrodes, each two of which are sandwiching an ion-transporting membrane. Each bipolar electrode forms an anode chamber on one side and a cathode chamber on the other side.

### BACKGROUND

An efficient method for production of hydrogen gas is electrolysis. In an electrolyzer, an ion conducting membrane is sandwiched between two electrodes, and a voltage is applied over the electrodes. The voltage results in water from the aqueous electrolyte being split into hydrogen and oxygen with a final separation of hydrogen gas and oxygen gas on opposite sides of the membrane.

Traditional alkaline electrolysis is based on a series of electrolytic cells. In each cell, two electrode plates are separated by a certain distance. The gap between the electrodes is filled with a liquid alkaline electrolyte. When sufficient voltage is applied, hydrogen is released on the cathode surface and oxygen is released on the anode surface. An ion conducting diaphragm between the electrodes prevents mixing of the gases. The electrolyte is circulated to remove the heat generated by the electrolytic process. The gap needs to be of sufficient width to allow the escape of hydrogen and oxygen bubbles without excessive blocking of the conductive path through the electrolyte from the anode to the cathode, and to allow electrolyte circulation without excessive pressure loss.

An electrode stack comprises a series of electrolytic cells. In this series of cells each electrode acts as an anode on one side and as a cathode on the other side. In such application the electrodes are designated as bipolar electrodes because they have different polarity on the two sides.

In later years, the configuration of traditional alkaline electrolyzers has been replaced by a so-called zero-gap configuration. In the zero-gap configuration the cell design works by pressing two porous electrodes onto either side of a hydroxide ion conducting membrane. This achieves a gap between the two electrodes equal to the thickness of the membrane, typically 0.5 mm or even less, rather than the 2-5 mm required for the traditional gap configuration. The smaller gap reduces the ohmic resistance contribution to the losses in the electrolytic cells.

In zero gap configuration, the electrodes need to have pores in order to allow the escape of hydrogen and oxygen bubbles to the side of the electrode not facing the membrane. In a bipolar electrode this arrangement would lead to mixing of hydrogen and oxygen in the chamber established between the cathode and the anode, which is not wanted. Therefore, a separator plate is inserted between the anode of one cell and the cathode of the neighboring cell, which prevents such mixing of the gases that are created by the electrolytic process. Hence, a bipolar electrode for a zero-gap electrolysis stack is typically composed of three metallic plates, namely a porous anode, a solid separator plate, and a porous cathode. The distance from the anode to the separator plate and from the separator plate to the cathode must be of sufficient width in order to allow electrolyte circulation without excessive pressure loss, and most importantly, in order to allow the escape of hydrogen and oxygen bubbles without excessive blocking, which otherwise would cause backpressure on the bubbles.

Examples of the electrolyzer arrangements are illustrated in US patent applications US2021/0234237 and US2021/0202963, where opposite separator plates are welded to each other.

US2021/0234237 discusses separator plates for electrochemical systems and discloses a bipolar separator made of two combined corrugated plates so that the corrugation forms cooling channels in between the two metal plates and gas transport channels on their outer sides. Bipolar plates are stacked and arranged on both sides of membrane electrode assemblies, MEA, typically sandwiched between gas diffusion layers, for example nonwovens. On its outer side, the corrugation is in contact with the gas diffusion layer. Generally, gas diffusion layers, between the membrane and the electrodes are used for proper flow and diffusion of the gas away from the membrane.

However, the more layers the electrolyzer cell comprises the higher is the risk that components are moving relative to each other and cause reduced efficiency or even malfunctioning of the electrolyzer. Accordingly, there is an interest of providing electrolyzer systems with high rigidity and sturdiness.

Among electrolyzer systems, there is a great variety. In some systems, membranes are provided as part of membrane electrode assemblies, in some cases flexible membrane electrode assemblies, others have metal meshes or grids pressing on the membrane or are provided with flexible gas diffusion layers. Some have a single bipolar plate between electrolyzer modules in a stack, others have double walled electrolyzers. Each principle representing an attempt to optimize hydrogen production. No conclusion has yet been found on the most efficient configuration, and for a skilled person, there are no specific starting points for an optimized system and no direction for how to optimize in the best way. Often, improvements are found by multiple trial and error attempts, where various features are put together in the hope to find further optimized systems.

EP0159138 discloses an electrolysis system for production of chlorine where a single corrugated bipolar electrode plate is sandwiched between membranes. The corrugation on either side comprises horizontal minor channels between major vertical channels, with a flow of electrolyte from the bottom, upwards through one major channel, then through minor channels to the adjacent major channel and then upwards through the adjacent channel and out of the chamber at the top. It is mentioned that this leads to rapid removal of the gases.

U.S. Pat. No. 5,114,547 is an offshoot of the system in EP0159138 and discloses an electrolysis system for production of chlorine where embossed corrugations in monopolar or bipolar metal electrode plates are formed in a herringbone pattern, where the minor channels extend inclined from the vertical major channels. This is explained as leading to improved flow and circulation of the electrolyte and further rapid removal of the formed gases. Optionally, the vertical major channels are provided with openings for electrolyte circulation. A herringbone pattern in a separator plate, for example formed by embossing, is also disclosed as one of several alternatives in US2007/0105000.

Whereas some systems regard circulation of electrolyte out of the top together with the gas as an advantage, with a subsequent separation of the gas from the electrolyte, others prevent such transport of electrolyte together with the gas in order to reduce the risk for cross over currents.

WO2022/156869 discloses an electrolysis system with single or double bipolar plates between hydrogen-producing electrolysis chambers, each chamber comprising a membrane sandwiched between perforated electrode plates which abut the membrane. The perforations allow gas transport from the membrane through the perforations and into the respective anode chamber and cathode chamber on opposite sides of the membrane. When two bipolar plates are used, coolant is introduced in the volume between the bipolar plates. The chambers are not fully filled with electrolyte, but a space for the gas accumulation and separation from the liquid is provided at the top, where the gas leaves the chamber through an opening above the liquid level. The separation of the gas from the electrolyte inside the chambers implies that only gas is transported out of the electrolyzer stack, thereby reducing the risk of shunt currents through the conductive electrolyte.

These examples illustrate only a few attempts in different directions for improved electrolysis. However, for optimization, there is still room for additional improvements. In particular, it would be desirable to provide improved hydrogen-producing electrolyzers that are simple in construction but robust, reliable, and efficient.

### BRIEF DESCRIPTION

It is therefore an objective of the present systems and methods to provide an improvement in the art. In particular, it is an objective to provide an electrolyzer with a high degree of operational reliability. Furthermore, it is an objective to provide an electrolyzer with a simple construction of a plurality of separator/electrode modules that sandwich membranes in between, where the modules are rigid and suitable for mass production at relatively low cost, and which allow for good temperature control of the electrolyzer. These objectives and further advantages are achieved with an alkaline electrolyzer for production of hydrogen gas as described below.

The electrolyzer comprises a stack of bipolar electrodes sandwiching ion-transporting membranes between two of the bipolar electrodes. Each bipolar electrode comprises two metal plates, in particular an anode metal plate and a cathode metal plate, mounted to each other, for example welded together, back-to-back and forming a coolant compartment in between. Such construction yields a high rigidity of the bipolar electrode.

The bipolar electrode has an anode surface and an opposite cathode surface, each of which is abutting one of the membranes. The metal plates are embossed with at least a first major vertical channel and a plurality of minor channels in a herringbone pattern for transport of oxygen and hydrogen gases. The minor channels of the embossed herringbone pattern are provided on both sides of the metal plates so as to also provide coolant channels in a herringbone pattern inside the coolant compartment. For example, the herringbone patterned minor channels of the anode plate and the cathode plate facing each other across the membrane face each other under different angles so that embossed minor channels in the anode metal plate cross embossed coolant channels in the cathode metal plate. The herringbone pattern enhances turbulence in the coolant compartment for efficient cooling of the electrolyte on the opposite side of the plates relative to the coolant compartment.

The primary objective of the electrolyzer is for production of hydrogen gas. The hydrogen is collected for later use, for example in fuel cells or industrial applications. However, due to the splitting of water in the electrolyte when applying electrical power, oxygen is also produced. The oxygen may also be collected for later use.

The two metal plates are electrically conducting and form an anode plate and a cathode plate. The bipolar electrode is abutting the respective two membranes and, respectively, form an anode chamber and a cathode chamber with the respective ion-transporting membrane. The electrode chambers contain electrolyte, in particular alkaline electrolyte, for example a NaOH or KOH based electrolyte.

In the above arrangement where the metal plates are abutting the membrane, the surfaces of the two metal plates serve as the electrolytically active parts of the electrolytic cell. Alternatively, an additional electrode layer is placed on top of one or both of the metal plate surfaces, resting on the embossed part of the metal plates, partly or completely abutting the respective membranes, and thereby partly or completely serving as the electrolytically active parts of the electrolytic cell.

Typically, the embossed pattern comprises not only one major channel but rather a plurality of major channels, typically vertical channels. The embossed minor channels, which are extending from each the major channels in a herringbone pattern, are fluid-flow communicating with the major channels. Oxygen and hydrogen gases are transported from the membrane through inclined minor channels into the major channel and further upwards through the major channel for release of the gases from the anode and cathode chamber through corresponding gas outlets provided in the electrolyzer.

A particular advantage of the arrangement can be established with a plurality of major channels being connected in the upper part of the electrode chambers above the minor channels. The advantage is that a significant circulation of the electrolyte is established within the volume delimited by an electrode surface on one side of the electrode chamber and the membrane on the opposite side of the electrode chamber.

For example, each of the electrode metal plates is provided with a first major vertical channel towards which a plurality of minor channels are upwards inclined so as to form a first herringbone pattern with the first major channel, and further, each of the electrode metal plates is provided with a second major vertical channel towards which the minor channels extend downwards inclined so as to form a second herringbone pattern with the second major channel, where the second herringbone pattern is circumvented relative to the first herringbone pattern. The minor channels communicate also with the second major channel but due to the upwards inclination towards the first major channel, the gas bubbles drift only towards the first major channel.

Advantageously, the first major channel and the second major channel are connected above the minor channels at an upper part of the respective electrode chamber and below the minor channels at a lower part of the respective electrode chamber, which causes increased circulation of electrolyte from the lower part upwards through the first major channel to the upper part above the minor channels and, then, to the second major channel prior to flowing downwards through the second major channel back to the lower part. Typically, as already outlined above, there are plural major channels of the first type with upwards flow and plural major channels of the second type with downwards flow.

In more detail, bubbles formed during the electrolysis process will flow in the upwards inclined minor channels, formed by the depressions in the embossed herringbone pattern of the electrode, and into those first major channels in an upwards path. Here, they form an upwards flow of bubbles. The bubbles will drag along electrolyte, leading to an upwards flow of electrolyte. At an upper part of the electrode chamber, the electrolyte will flow largely horizontally to the neighbouring second major channels and then downwards. As a result, a downwards flow of electrolyte will occur in those neighbouring second major channels. At the bottom of the electrode the electrolyte will flow horizontally back to the adjacent first major channels towards which minor channels extend in an upwards inclined path formed by the depressions in the embossed herringbone pattern of the electrode, and there return to an upwards flow.

The electrode is cooled on the opposite side of the active surface due to the circulation of a coolant in the coolant chamber between the two electrode metal plates that form the bipolar electrode. Even though the heat transfer from the coolant to the electrode is facilitated by the embossed herringbone pattern of the back side of the electrodes, a completely evenly cooled electrode surface is unattainable. Nevertheless, due to the bubble-driven circulation, as described above, a volume of electrolyte over a relatively short period of time comes into contact with a large area of the electrode. As a result, the total volume of electrolyte in the electrolytic cell will reach a much more uniform temperature than would be the case if no such bubble-driven circulation were taking place.

In practical embodiments, the gas outlets connect the anode chamber with an oxygen transport conduit and the cathode chamber with a hydrogen transport conduit. Optionally, the oxygen transport conduit and/or the hydrogen transport conduit extend along the stack through openings in the anode and cathode plates. For example, sealings are provided between the bipolar electrodes so that the openings in the stack of bipolar plates, optionally in addition to corresponding openings in membrane-holding frames, form a longitudinal gas conduit through and along the stack.

A further important advantage is obtained by the present devices and systems as explained in the following where a comparison is made between traditional electrolyzers and those of the present disclosure.

In a traditional arrangement of electrolyzer stacks, a fairly uniform cooling of the electrolyzer stack can be obtained only through significant circulation of the electrolyte and a corresponding high pumping rate by an external pump. As the arrangements require substantial flow volumes, the corresponding electrolyte flow paths through the electrode stack have to be large in order to keep pressure losses in the flow paths at a manageable level. When filled with the highly conductive electrolyte, these flow paths act as shunts, connecting all cells in the stack, including those at the ends having the full potential difference of the stack. The shunt currents flowing in the flow paths may reach levels of several percent of the total current in the stack. Since the shunt currents do not contribute to electrolysis at the desired locations in the stack, they give rise to losses of the same ratio as the ratio of the shunt currents to the total current.

In contrast to these traditional arrangements, the arrangement of the electrolyzer stack disclosed herein provides internal circulation of the electrolyte in the electrolytic cell through the bubble-driven circulation, as described above. Consequently, no pump-driven circulation of the electrolyte is necessary. Only a continuous replenishment of the electrolyte is necessary. However, the electrolyte flow required for this system is a tiny fraction of the electrolyte flow that would be required for cooling according to the traditional methods. As a result, the electrolyte flow paths through the electrode stack can have much smaller cross-sections while still keeping the pressure losses in the flow paths at a manageable level. The shunt currents are proportional to the cross-sections of the flow paths, and the effect of the much smaller cross-sections of the flow paths is that shunt losses are significantly reduced as compared to traditional arrangements, leading in turn to correspondingly reduced losses.

In practical embodiments, for providing tightness, the anode plate and the cathode plate may be welded together back-to-back, typically along a closed curve, for example by a perimeter welding at the rim, and advantageously around the inlets and outlets and the conduits. Alternatively, the two metal plates are pressed against each other, with a sealing achieved by glue or sealing gaskets, typically along or close to the perimeter and around the conduits.

The cross-section of the embossed pattern that forms the channels is optionally smoothly alternating, for example being approximately sinusoidal. An approximately sinusoidal cross-section reduces the contact area between the membrane and the anode and cathode surfaces. Despite deformation of the membrane and the embossed plate, the contact area is minimized to only a few percent of the membrane surface area.

Alternatively, the cross-section of the embossed pattern that forms the channels is polygonal. A polygonal cross-section can be made to have the same small contact area between the membrane and the anode and cathode surfaces, but it may also be made to have a significant part of the anode and cathode surfaces in close contact.

For example, the minor channels may have a depth in the range of 0.3 mm to 3 mm with areas in between the minor channels abutting the membrane.

In some advantageous embodiments, the minor channels may have a length on the order of 50 to 200 mm and a width on the order of 2 to 10 mm. For example, the length may be 10 to 50 times the width.

In some embodiments, supplementary electrodes may be placed on the anode and/or the cathode. Such supplementary electrodes are optionally coated with a catalytic material.

In some embodiments, the herringbone patterned coolant channels of the anode plate and the cathode plate face each other under different angles so that at least some of the embossed minor gas flow channels in the anode cross at least some of the minor embossed gas flow channels in the cathode. The crossing of minor channels in the opposite plate surfaces in the coolant compartment has turned out to lead to improved cooling of the electrolyte as compared to channel patterns that are mirror-images of each other in the coolant department.

The minor channels in the coolant department also comprise grooves and ridges between the grooves. The ridges of the minor channels advantageously touch each other at their crossing points inside the coolant compartment, which not only improves turbulence inside the coolant compartment but also ensures rigidity of the bipolar plate and many electrical contact points. The rigidity of the bipolar plate also results in a firmly held position of the membranes between the bipolar plates in the stack.

By suitable selection of the angles of the minor channels a high number of such contact points will be established. This leads to a good transfer of current from the anode to the cathode, thereby minimizing the ohmic losses caused by the need for lateral current flow in the electrode plates.

In a further advantageous embodiment, the electrolyte is provided in the anode and/or cathode chambers up to a level that is below the corresponding gas outlet for separating the gas from the electrolyte and preventing the electrolyte from flowing through the gas outlet. In this case, if a circulation outlet is provided for the electrolyte, it is below the electrolyte surface in the electrolyte chambers and not at the top.

An even further advantage is achieved if the coolant compartment has a coolant inlet at the top, potentially a coolant outlet at the bottom, and is arranged for cooling the gases above the electrolyte and causing condensation of liquid, especially water, from the gases prior to the gases leaving the anode and cathode chambers through the gas outlets, which leads to dry gases with further reduced risk for cross currents.

For supply of water to the anode chamber and the cathode chamber, in order to replenish consumed water, each chamber may comprise one or more water inlets. Alternatively, or in addition, if water, consumed in the electrolysis process, is added to the electrolyte outside the electrolytic cells, each chamber may comprise one or more electrolyte inlets.

Typical dimensions are given in the following:
Thickness of plates: 0.3 mm to 1.0 mm
Length/width of the plates: 0.3 m to 3 m
Depth of embossed minor channels in herringbone pattern: 0.3-3 mm

As a separator membrane for alkaline water electrolysis, typically, polymer membranes are used. For example, the membrane comprises an open mesh polyphenylene sulfide fabric which is symmetrically coated with a mixture of a polymer and zirconium oxide. The latter is advantageous for systems in which the electrolyte is used at elevated temperatures, for example in the range of 50° C.-90° C.

### BRIEF DESCRIPTION OF THE DRAWINGS

The systems and methods will be explained in more detail with reference to the drawings, where

FIG. 1 is a sketch of an electrolyzer stack, according to an embodiment;

FIG. 2A illustrates an electrode assembly in the stack, according to an embodiment;

FIG. 2B shows an enlarged section of FIG. 2A;

FIG. 3 illustrates the electrolyte level in the anode and cathode volumes as well as the various conduits, according to an embodiment;

FIG. 4 illustrates circulation of the electrolyte, according to an embodiment;

FIG. 5A illustrates a sinusoidal cross section of the metal plate, according to an embodiment;

FIG. 5B illustrates a sinusoidal cross section of the metal plate abutting the membrane, according to an embodiment;

FIG. 5C illustrates a triangular cross section of the metal plate, according to an embodiment;

FIG. 5D illustrates a triangular cross section of the metal plate with rounded edges, according to an embodiment;

FIG. 6A is a cross section of a cathode plate in combination with a perforated screen, according to an embodiment; and

FIG. 6B is a cross section of a cathode plate in combination with a metal net, according to an embodiment.

### DETAILED DESCRIPTION

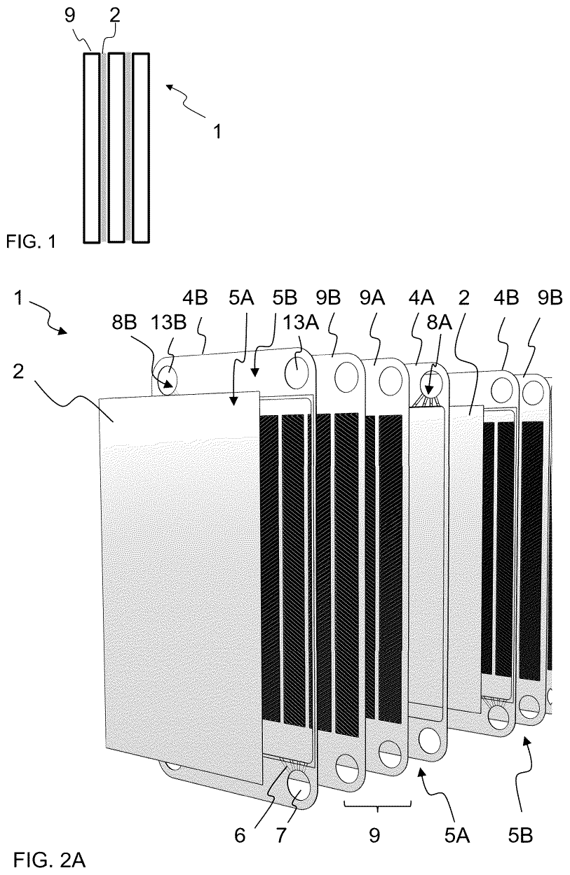

FIG. 1 is a sketch of a principle of a stacked electrolyzer 1 comprising ion-transporting membranes 2 sandwiched between bipolar electrodes 9.

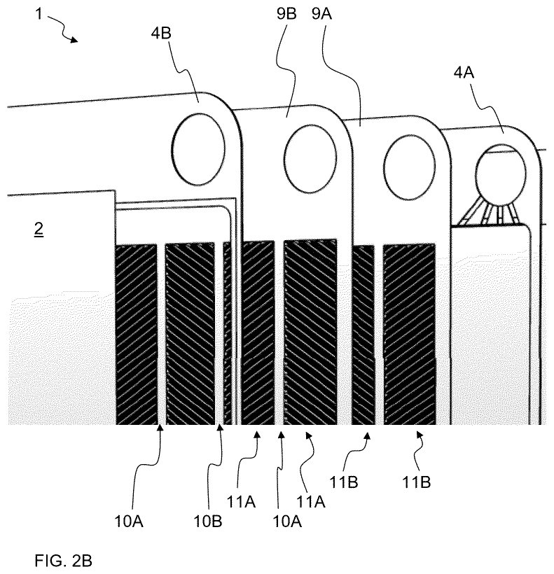

FIG. 2A illustrates some details of electrolyzer 1. The membrane 2 is supported by a first frame 4A and a second frame 4B. The first frame 4A together with the membrane 2 forms one side of an anode chamber 5A, and an anode plate 9A forms an opposite side of the anode chamber 5A. The second frame 4B together with the membrane 2 forms one side of a cathode chamber 5B, and a cathode plate 9B forms an opposite side of the cathode chamber 5B. Both chambers 5A, 5B contain the necessary electrolyte for the electrolytic reaction where water is split into oxygen and hydrogen, which are extracted from the anode chamber 5A and cathode chamber 5B, respectively.

In order to replenish the water that is consumed during the reaction, the frames 4A, 4B have a water inlet 6 with supply of water from a water supply conduit 7. For removing the oxygen and hydrogen gases from the respective chambers 5A, 5B, the frames 4A, 4B have corresponding gas outlets 8A, 8B on opposite sides of the membrane 2 and in the upper part of the frames 4A, 4B. The gas outlets 8A and 8B lead into corresponding oxygen gas transport conduit 13A and hydrogen gas transport conduit 13B.

In practice, the anode plate 9A and the cathode plate 9B are assembled back-to-back into a bipolar electrode 9 with a liquid-tight coolant compartment in the volume between the anode plate 9A and the cathode plate 9B for cooling of the bipolar electrode 9 and, thus, also cooling of the electrolyte in the electrode chambers 5A, 5B. Typically, the anode plate 9A and the cathode plate 9B are provided as stainless steel plates and welded together back-to-back, for example along a rim portion of the coolant compartment. Coolant conduits, not shown in FIG. 2A, are provided at top and bottom for flow of coolant through the coolant compartment between the plates 9A, 9B.

FIG. 2B is an enlarged portion of the drawing in FIG. 2A. It illustrates that the anode plate 9A as well as the cathode plate 9B on their membrane-facing side are provided with first major channels 10A and second major channels 10B that are embossed into the plates 9A, 9B transverse to the membrane 2 and with inclined minor channels 11A extending in an upwards directed herringbone pattern towards the first major channels 10A and in a downwards directed herringbone pattern towards the second major channels 10B. The herringbone pattern, where the minor channels 11A extend inclined upwards towards the first vertical major channel 10A, causes flow of gas bubbles from the inclined minor channels 11A into the first major channels 10A. This improves upward flow and circulation of the electrolyte as well as rapid removal of the formed gases, due to the combined upward movement of the gas and the electrolyte in the first major channels 10A.

As the herringbone pattern of the minor channels 11A is provided by embossing an alternating pattern into the metal sheets of the anode plate 9A and the cathode plate 9B, inclined minor channels 11A are not only present on the membrane-facing side of the anode plate 9A and the cathode plate 9B, but inclined minor channels are correspondingly provided on the sides towards the coolant compartment in between the plates 9A, 9B and function as inclined coolant channels 11B.

The flow and circulation of the coolant is improved if the coolant channels 10B of the anode plate 9A are reversed relative to the coolant channels 10B of the cathode plate 9B inside the coolant compartment so that upwards inclined coolant channels 11B on the backside of the anode plate 9A are crossing downwards inclined coolant channels 11B on the backside of the cathode plate 9B and vice versa. Such crossing of embossed coolant channels 11B in the coolant compartment increases turbulence of the coolant while flowing through the coolant compartment in between the anode plate 9A and the cathode plate 9B. This is an improvement relative to the system in the above-discussed disclosure of U.S. Pat. No. 5,114,547.

For example, the two opposite embossed patterns of the coolant channels 11B in the coolant compartment are advantageously pressed together so that the ridges of the embossed patterns of the coolant channels 11B in the coolant compartment are abutting each other. Similar to the improved flow and circulation of the electrolyte, also the flow and circulation of the coolant is improved by the herringbone pattern. Additionally, the abutting ridges provide contact points for improved electrical conduction.

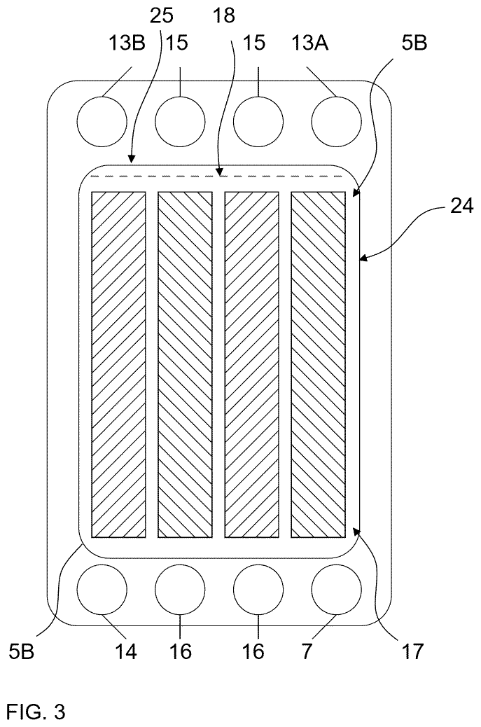

With reference to FIG. 2A, in order for the electrolyte in the anode chamber 5A and in the cathode chamber 5B not to exit the respective chambers 5A, 5B through the gas outlets 13A, 13B, the liquid level 12 of the electrolyte is below the level of the respective gas outlets 8A, 8B, which is exemplified in the illustration of FIG. 3. In particular, FIG. 3 exemplifies an arrangement of transport conduits, namely oxygen gas transport conduit 13A, hydrogen gas transport conduit 13B, coolant inlet conduit 15, coolant outlet conduit 16, water supply conduit 7, and electrolyte supply conduit 14. The cathode chamber 5B, and similarly the anode chamber 5A, is delimited by a gasket 24 surrounding an active area of the membrane 2. The electrolyte 17 extends to an uppermost level 18 that is below a top 25 of the respective chambers 5A, 5B and, thus, below the gas outlets 8A, 8B, see also FIG. 2A, and below the gas transport conduits 13A, 13B, as illustrated in FIG. 3, so that oxygen gas and hydrogen gas are separated from the electrolyte 17 prior to entering the respective gas transport conduits 13A, 13B. This results in reduced risk for cross-over currents. In particular, only hydrogen gas is flowing though the hydrogen gas outlet 8B, see FIG. 2A, and into the hydrogen gas transport conduit 13B and not electrolyte or water.

In the present system, a further advantage is achieved by flow of the coolant from a coolant inlet conduit 15 at the top to a coolant outlet conduit 16 at the bottom of the coolant chamber in the bipolar double-sheet electrode plate 9. As the coolant enters at the top, the highest cooling effect is at the top. This implies that the gas in the electrode chambers 5A, 5B is cooled most efficiently at the top prior to leaving the electrode chambers 5A, 5B. The efficient cooling leads to condensation of water from the gas so that the gas that exits through the gas outlets 8A, 8B is dry, thus, reducing the risk for crossover currents even further. This is a particular improvement relative to the system in the above discussed disclosure of WO2022/156869.

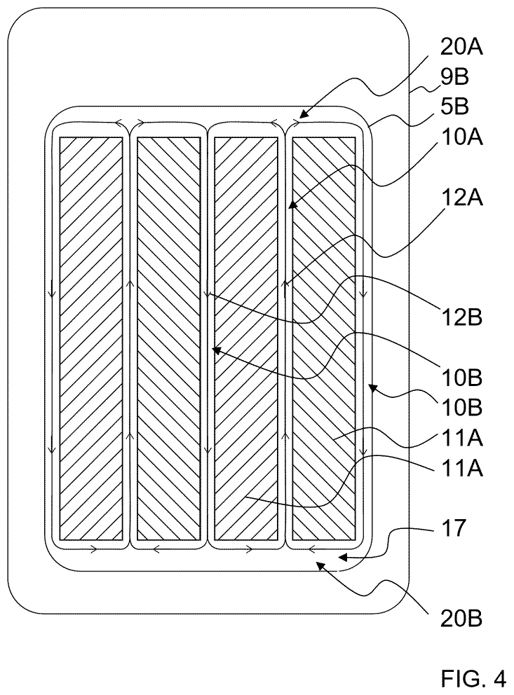

FIG. 4 illustrates by arrows 12A, 12B the principle of the flow of the electrolyte in the cathode chamber 5B. The flow of the gas bubbles is upwards, as indicated by an upwards directed arrow 12A, in the first major channel 10A towards which the minor channels 11A are inclined upwards. The moving gas bubbles also drag the electrolyte 17 along, which causes a circulation of the electrolyte 17 upwards in the first major channels 10A and downwards, as indicated by the downwards directed arrows 12B, in the neighboring, second major channels 10B towards which the minor channels 11A extend with a downwards inclination.

The herringbone pattern with the minor channels 11A in the electrode chambers 5A, 5B and the herringbone pattern of the coolant channels 11B in the coolant compartment are provided by embossing into the metal sheets of the anode plate 9A and the cathode plate 9B.

The cross-section of the embossed pattern that forms the minor channels 11A and coolant channels 11B may be smoothly alternating, for example being sinusoidal. Alternatively, the cross-section of the embossed pattern forming the minor channels 11A and minor coolant channels 11B is polygonal. A polygonal cross-section optionally has a similar small contact area between the membrane 2 and the anode and cathode surfaces, but it may also be made to have a significant part of the anode surface and cathode surface in close contact.

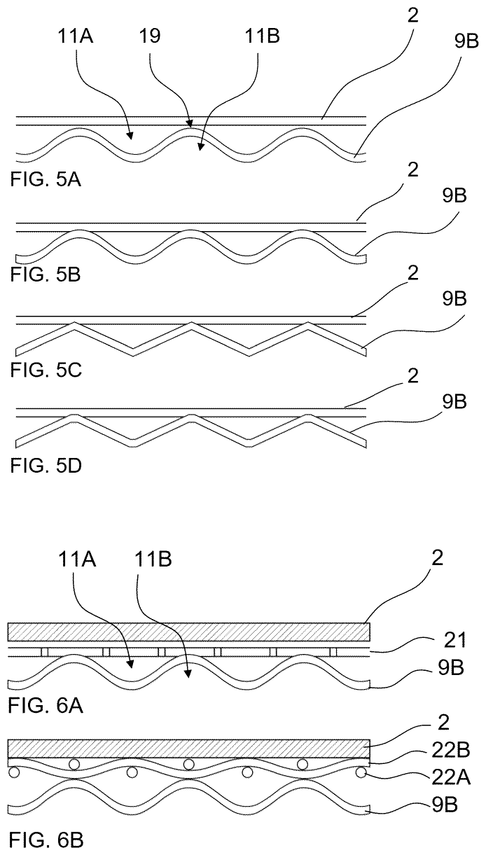

FIG. 5A, 5B, 5C, and 5D illustrate examples of possible embossing in a cathode plate 9B in a cross section along a line perpendicular to the minor channels 11A formed by the herringbone pattern along the membrane 2. In FIG. 5A, the cross section follows a sinusoidal curve along a line transverse to the minor channels 11A. The ridges 19 of the curve are provided in close proximity to the membrane 2. Alternatively, as illustrated in FIG. 5B, for which the same numerals are valid as for FIG. 5A, the ridges 19 of the embossing are resting against the membrane 2. By a pressing force, the ridges 19 press slightly into the membrane 2 for good conductivity and optimized electric field strength, while the gases produced at the ridges 19 flow into the minor channels 11A and from there into the first major channels 10A, which are valleys of the embossing, so that the gases are transported upwards to the gas outlets 8A, 8B and into the respective gas channels 13A, 13B as explained in connection with FIG. 2A and FIG. 3.

Other cross-sectional alternating shapes are possible, for example a triangular alternating curve with sharp edges, as illustrated in FIG. 5C, or a triangular alternating curve with rounded edges, as illustrated in FIG. 5D.

Despite deformation of the membrane 2 and the embossed plate 9B, the contact area is minimal. Only a few percent of the active membrane surface area, due to the ridges 19 resting against the membrane 2 and potentially impressed portions of the membrane 2, are in contact.

FIG. 6A illustrates an arrangement in which the electrode comprises a corrugated metal plate 9B, as described above, and a supplementary perforated electrode layer 21, for example a thin perforated conducting sheet, placed between the metal plate 9B and the membrane 2 and resting on the embossed part of the metal plate 9B. Optionally, the supplementary electrode layer may be a metal wire net with first wires 22A and second wires 22B that are crossing each other, or it may be any other perforated conducting material, advantageously having catalytic properties.

What is claimed is:

1. An electrolyzer for production of hydrogen gas, the electrolyzer comprising:
a stack of bipolar electrodes sandwiching ion-transporting membranes between pairs of the bipolar electrodes, wherein each bipolar electrode comprises an electrically conducting anode metal plate and an electrically conducting cathode metal plate mounted to each other back-to-back forming a coolant compartment in between,
wherein the anode metal plate forms an anode chamber with one of the ion-transporting membranes in the stack and the cathode metal plate forms a cathode chamber with another one of the ion-transporting membranes in the stack, wherein the anode chamber and the cathode chamber contain electrolyte,
wherein the anode and cathode metal plates are each embossed with a first major channel and a plurality of minor channels which are upwardly inclined towards the first major channel so as to form a herringbone pattern with the first major channel,
wherein the minor channels fluidly communicate with the first major channel for transport of oxygen and hydrogen gases from the anode chamber and cathode chamber, respectively, through the upwardly inclined minor channels into the first major channel and further upwards in the first major channel for release of the oxygen and hydrogen gases through corresponding gas outlets provided in the electrolyzer, and
wherein the herringbone pattern is provided on both sides of each of the anode and cathode metal plates so as to also provide coolant channels having the herringbone pattern inside the coolant compartment.

2. The electrolyzer according to claim 1, wherein the minor channels of the anode metal plate and the minor channels of the cathode metal plate facing each other across the ion-transporting membrane face each other at different angles such that at least some of the minor channels in the anode plate cross at least some of the minor channels in the cathode plate.

3. The electrolyzer according to claim 1, wherein the herringbone patterns of the minor channels are arranged with upwardly inclined minor channels of the anode metal plate crossing downwardly inclined minor channels of the cathode metal plate and vice versa.

4. The electrolyzer according to claim 1, wherein the herringbone patterns of the coolant channels of the anode metal plate and the cathode metal plate inside the coolant compartment face each other at different angles so that the coolant channels in the anode metal plate cross the coolant channels in the cathode metal plate.

5. The electrolyzer according to claim 1, wherein each of the anode metal plate and the cathode metal plate is provided with a second major channel towards which the minor channels extend downwardly inclined so as to form a herringbone pattern with the second major channel, wherein the minor channels fluidly communicate with the second major channel, wherein the first major channel and the second major channel are connected above the minor channels at an upper part of the respective electrode chamber and below the minor channels at a lower part of the respective electrode chamber for increasing circulation of electrolyte from the lower part upwards through the first major channel to above the minor channels, from the first major channel to the second major channel, and then downwards through the second major channel to the lower part.

6. The electrolyzer according to claim 1, wherein the bipolar electrode comprises a supplementary, porous, electrically conducting electrode layer on the anode metal plate, the cathode metal plate, or both the anode metal plate and the cathode metal plate, wherein the supplementary, porous, electrically conducting electrode layer abuts the ion-conducting membrane.

7. The electrolyzer according to claim 1, wherein electrolyte is provided in the anode chamber and the cathode chamber up to a level that is below the gas outlets for separating the oxygen and hydrogen gases from the electrolyte and preventing the electrolyte from flowing through the gas outlets.

8. The electrolyzer according to claim 7, wherein the coolant compartment has a coolant supply from a coolant conduit at a top of the coolant compartment, arranged for cooling the gases in the anode and cathode chambers above the electrolyte for causing condensation of liquid in the gases prior to the gases leaving the anode and cathode chambers through the gas outlets.

9. The electrolyzer according to claim 1, wherein the minor channels have a depth in a range of 0.3 mm to 3 mm.

10. The electrolyzer according to claim 1, wherein the minor channels have a length of 50 to 200 mm, a width of 2 to 10 mm, and a ratio of the width to the length of 10 to 50.

11. The electrolyzer according to claim 1, wherein the gas outlet for oxygen connects the anode chamber with an oxygen transport conduit and the gas outlet for hydrogen connects the cathode chamber with a hydrogen gas transport conduit, wherein the oxygen gas transport conduit and the hydrogen gas transport conduit extend along the stack through openings in the anode plates and the cathode plates.

12. The electrolyzer according to claim 1, wherein the minor channels of the anode metal plate and the minor channels of the cathode metal plate facing each other across the ion-transporting membrane are rotated relative to one another around an axis perpendicularly penetrating both the anode metal plate and the cathode metal plate.

13. The electrolyzer according to claim 1, wherein the herringbone patterns of the coolant channels of the anode metal plate and the cathode metal plate inside the coolant compartment face each other at different angles so that the coolant channels in the anode metal plate cross the coolant channels in the cathode metal plate when viewed along an axis perpendicularly penetrating both the anode metal plate and the cathode metal plate.
